(19) United States
(12) Patent Application Publication
(10) Pub. No.: US 2002/0039419 A1
(43) Pub. Date: Apr. 4, 2002

(54) Encrypting device and method of encrypting

(75) Inventors: Masao Akimoto, Tokyo (JP); Matsutoshi Murata, Tokyo (JP)

Correspondence Address: GREENBLUM & BERNSTEIN, P.L.C., 1941 ROLAND CLARKE PLACE, RESTON, VA, 20191, US

(73) Assignee: MATSUSHITA GRAPHIC COMMUNICATION SYSTEMS, Inc., Tokyo (JP)

(21) Appl. No.: 09/861,603

(22) Filed: May 22, 2001

(30) Foreign Application Priority Data
Jul. 21, 2000 (JP) 2000-220189

(51) Int. Cl. H04N 1/44

(52) U.S. Cl. 380/243

(57) ABSTRACT

An encrypting device is provided that ensures confidentiality of an email transmitted from an Internet facsimile machine (IFAX), without any additional components or construction added to an existing IFAX. A signal type detecting section detects a type of a signal received through an interface section connected to an IFAX. When a predetermined signal type is detected, a mail data communication section receives email data. Then, after an encrypting section encrypts the received email data, the mail data communication section transmits the encrypted email data through an interface section connected to a network.

### BACKGROUND OF THE INVENTION

1. Field of the Invention

The present invention relates to an encrypting device that is connected to an Internet facsimile machine and a method of encrypting. The device or method encrypts email data transmitted from the Internet facsimile machine, and decrypts encrypted email data received by the Internet facsimile machine.

2. Description of Related Art

Recently, a facsimile machine that can send image picture information via Internet by an operation similar to that for a usual facsimile machine is developed. This type of facsimile machine is called an Internet facsimile machine (hereinafter referred to as IFAX), because it uses Internet as an entire or a part of a transmission path.

This type of IFAX transmits data converted from a facsimile data format to an email data format. More specifically, the IFAX converts a scanned document to MH data and converts the MH data to a TIFF file. Further, the TIFF file is converted to text codes and the data converted from the text codes to MIME format data are transmitted.

However, the IFAX mentioned above does not have encrypting process to ensure confidentiality of emails when email data are transmitted. Therefore, there is a problem that the transmitted email data could be read or could be (rewritten) altered by a third person.

To resolve this problem, a control board that has an encrypting function is installed inside the IFAX or a control program of the IFAX is modified.

However, since various types of IFAXes are in use now, it is necessary to develop various control boards corresponding to various types of IFAXes to install an encrypting function to the various types of IFAXes. Even if such boards are developed, it is very complicated to install them to integrated devices such as an IFAX.

The present invention is proposed with respect to the above-mentioned problem and is directed to provide an encrypting device and an encrypting method that ensure confidentiality of an email transmitted from an IFAX without addition of special parts or components to an existing IFAX.

### SUMMARY OF THE INVENTION

In the present invention, a predetermined signal is detected from signals received via a first interface section connected to an Internet facsimile machine and email data is received when the predetermined signal is detected. After received email data is encrypted, the encrypted email data is transmitted via a second interface section connected to the Internet facsimile machine.

To achieve the above and or other goals, the present invention provides an encrypting device that includes a first interface section connected to an Internet facsimile machine, a second interface section connected to a network, a signal type detecting section that detects a type of a signal communicated via at least one of the first and second interface sections, a mail communication section that receives email data when the signal type detecting section detects a predetermined signal type, and an encrypting section that performs at least one of encryption and decryption on the email data received by the mail communication section.

According to this construction, an encrypting device is connected to an existing Internet facsimile machine via the first interface section and to Internet via the second interface section. When the signal type detecting section detects a predetermined signal type, email data is received and an encrypting section encrypts the email data. Thus, it is possible to ensure confidentiality of emails transmitted from an Internet facsimile machine without adding any special components or construction to an existing Internet facsimile machine.

In another aspect of the present invention, in the encrypting device described above, when the signal type detecting section detects a signal type different from the predetermined signal type, the signal type detecting section relays the signal to an recipient of the signal, without processing the signal.

According to this construction, when a signal type different from a predetermined type is detected, the signal is directly relayed to the recipient and encrypting/decrypting process is executed only when the predetermined signal type is detected. Thus, the process of the encrypting device is simplified because the encrypting/decrypting process is executed only for the data required to be processed.

In still another aspect of the present invention, the encrypting device described above further includes an IC card that stores information necessary for the encrypting or decrypting of the encrypting section, and a slot section to which the IC card is inserted. The encrypting section uses the information stored in the IC card when the IC card is inserted in the slot section.

According to this construction, it is possible to decide easily the necessity of the encrypting or decrypting, because the encrypting or decrypting is executed using the information stored in the IC card only when the IC card is inserted to the slot section.

It is also possible to encrypt/decrypt emails only in a necessary case, by delivering IC cards to users of the encrypting device. In this case, it is possible to prevent the information to be rewritten by other people, because the information necessary for encrypting/decrypting is managed in the IC card possessed by each user.

In further aspect of the present invention, in the encrypting device described above, the IC card stores email address information and the mail communication section transmits/receives email data using the email address information stored in the IC card, when the IC card is inserted into the slot section.

According to this construction, the mail communication section transmits/receives email data only when the IC card is inserted into the slot section. In this case, the email address information stored in the IC card is used for transmitting/receiving process. Thus, even when multiple users use a single Internet facsimile machine, it is possible to send email data from one's mail address, and it is also possible to receive email data addressed to one's mail address without seen by other people. Thus, it is possible to avoid the case that other people see email data addressed to oneself and confidentiality of email data is secured.

In another aspect of the present invention, an encrypting device includes a first interface section to be connected to an Internet facsimile machine, a second interface section to be connected to the network, a signal type detecting section that detects a type of a signal communicated via at least one of the first and second interface sections, a mail communication section that receives email data when the signal type detecting section detects a predetermined signal type, and an IC card that is capable of encrypting/decrypting the email data and a slot section to which the IC card is inserted.

According to this construction, an encrypting device is connected to an existing Internet facsimile machine via the first interface section and to network via the second interface section. Email data is received when the signal type detecting section detects a predetermined signal type and the received data is encrypted/decrypted using a program stored in the IC card. Thus, without any addition of components or construction to an existing Internet facsimile machine, confidentiality of the email transmitted from the Internet facsimile machine is ensured. In this process, it is possible to more securely prevent the information necessary for encrypting/decrypting from being seen by other people, comparing with the case where the information necessary for encrypting/decrypting process is simply stored, because the IC card receives the email data and encrypts/decrypts the received email data.

In still another aspect of the present invention, an encrypting method is provided. The encrypting method includes: detecting a predetermined signal type from a received signal via a first interface section connected to an Internet facsimile machine, receiving email data when the predetermined signal type is detected, encrypting/decrypting the received email data, and transmitting the encrypted/decrypted email data via a second interface section connected to a network.

In another aspect of the present invention, there is provided a decrypting method including: detecting a predetermined signal type from a signal received via a first interface section connected to a network, receiving email data when the predetermined signal type is detected, determining whether the received email data is encrypted or not, decrypting the email data when the email data is encrypted, and transmitting the decrypted email data via a second interface section connected to an Internet facsimile machine.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 is a schematic view showing a network in which an encrypting device according to an embodiment of the present invention operates.

FIG. 2 is a block diagram showing hardware configuration of the ADPT in the embodiment mentioned above.

FIG. 3 is a block diagram showing main (primary) functions of the ADPT in the embodiment mentioned above.

FIG. 4 is a sequential chart illustrating a case where the IFAX, to which the ADPT of the embodiment mentioned above is connected, transmits emails to a mail server.

FIG. 5 is a flowchart showing a process, such as signature encryption for the image data that the ADPT of the embodiment mentioned above receives from IFAX.

FIG. 6 is a sequential chart illustrating a case where the IFAX, to which the ADPT of the embodiment mentioned above is connected, receives emails from a mail server.

FIG. 7 is a flowchart showing a process in which the ADPT of the embodiment mentioned above receives image data from a mail server and decrypts the image data on which the signature encryption, or the like, is performed.

### DETAILED DESCRIPTION OF THE PREFERRED EMBODIMENTS

Hereinafter, embodiments of the present invention are described in more detail referring to drawings.

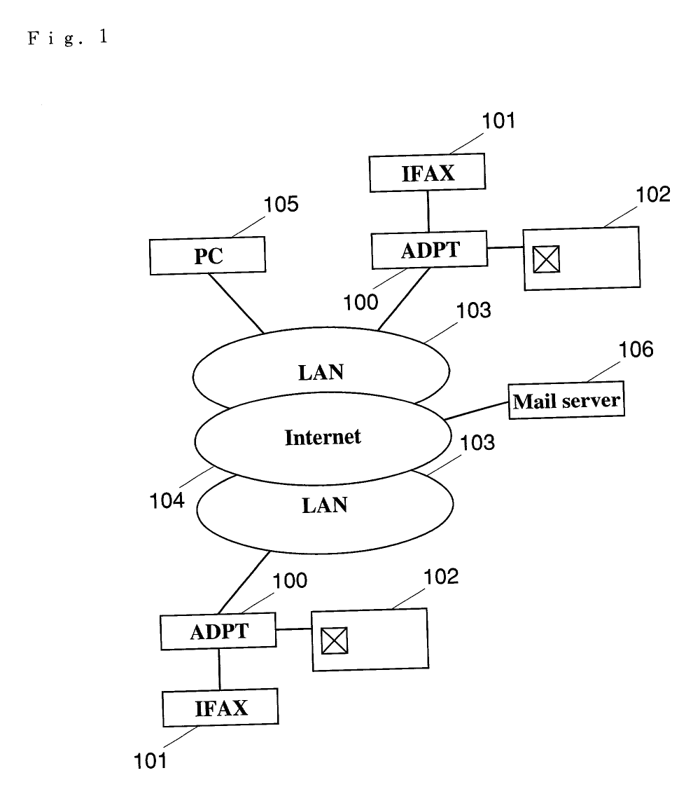

FIG. 1 is a schematic view of a network in which an encrypting device of an embodiment of the present invention operates. An encrypting device 100 of the embodiment is connected to an IFAX 101.

Hereinafter, the encrypting device 100 is simply called an adapter (ADPT) in this embodiment, because the encrypting device of the embodiment is an adapter that is connected to the IFAX 101 and has a function to encrypt email data transmitted from the IFAX 101 or to decrypt email data received by the IFAX 101. The ADPT 100 can be provided with an IC card 102 and controls a process, such as an encrypting process, based on whether the IC card 102 is inserted or not. Detailed control of ADPT 100 will be described later.

The ADPT 100 connected to the IFAX 101 is connected to Internet 104 via LAN (Local Area Network) 103. A PC 105, which is a communication terminal capable of transmitting/receiving emails from/to the IFAX 101 connected to the ADPT 100, is connected to LAN 103. In this case, the LAN 103 is constructed by Ethernet, but wireless LAN can also be used. A mail server 106 that stores emails from the IFAX 101 and PC 105 is connected to Internet 104.

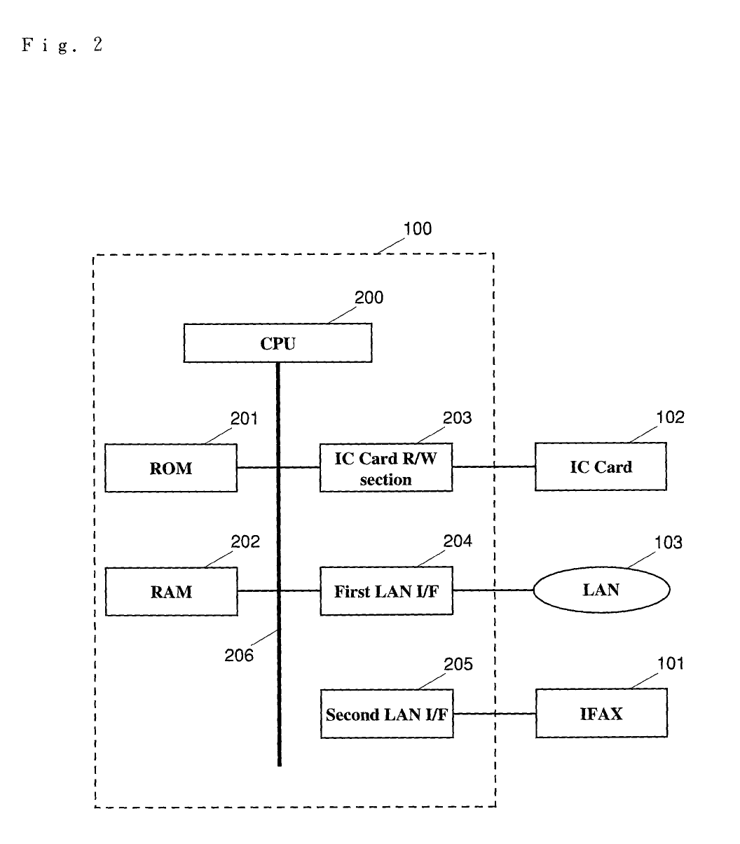

FIG. 2 is a block diagram showing a hardware configuration of the ADPT 100 of the present embodiment.

A CPU 200 controls ADPT 100 executing various programs. ROM 201 stores programs that CPU 201 executes. RAM 202 is used as a program data area and as a memory to store predetermined data.

A READ/ WRITE section of the IC card (hereinafter referred to as “IC card R/W section”) 203 writes predetermined data to the IC card 102 inserted in an IC slot section, which is not shown in the drawing, or reads data written in the IC card 102. The data written in the IC card is described in detail later.

The first LAN interface (hereinafter referred to as “first LAN I/F”) 204 is an interface that controls data communication with LAN 204. The second LAN interface (hereinafter referred to as “second LAN I/F”) 205 is an interface that controls data communication with the IFAX 101. Here, the second LAN I/F 205 can be connected to all types of existing IFAXes 101 and is not restricted by the specification of each type of the IFAX 101. With these two LAN I/Fs, the ADPT 100 of the embodiment operates between the IFAX 100 and LAN 103.

Bus 206 is a communication path on which data are transferred among CPU 200, ROM 201, RAM 202, IC card R/W section 203, the first LAN I/F 204 and the second LAN I/F 205.

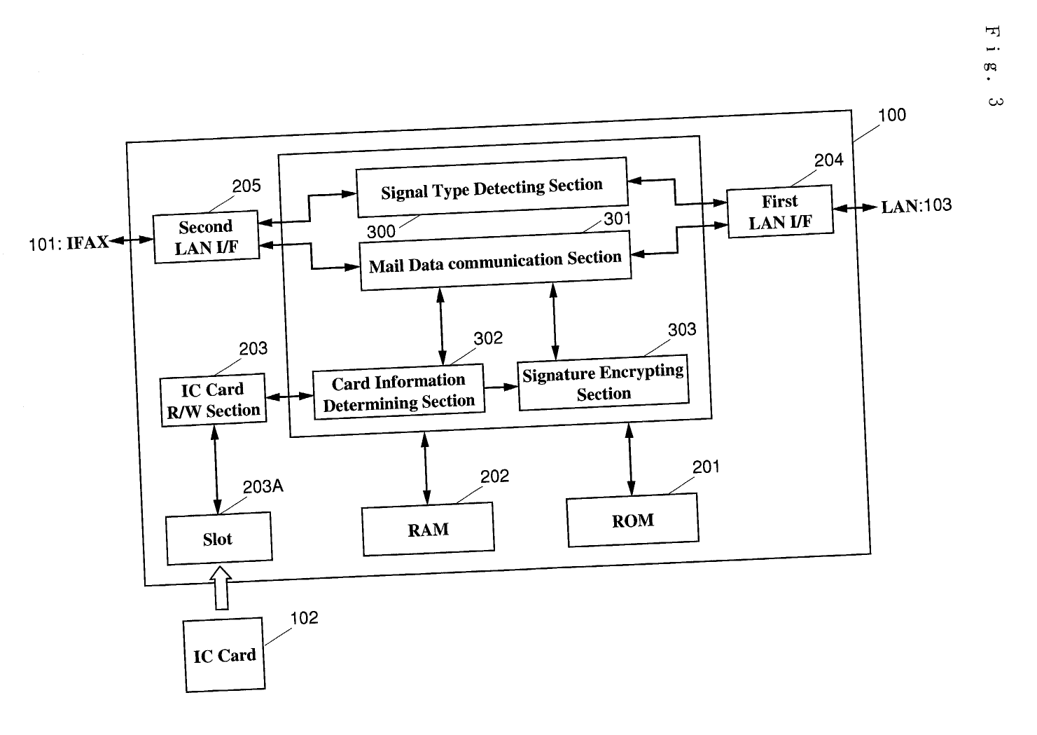

FIG. 3 is a block diagram showing primary functions of the ADPT 100 mentioned above.

The signal type detecting section 300 detects a type of a predetermined command signal (response signal) output from the second LAN I/F 205 in the process transmitting email data from the IFAX 101 or a type of a predetermined command signal (response signal) output from the first LAN I/F 204 in a process receiving email data from LAN 103. When the type of the predetermined signal is detected, the signal type detecting section 300 recognizes that the second LAN I/F 205 and the first LAN I/F 204 output an email data subsequently, and notifies it to a mail data communication section 301.

Here, in the process transmitting email data from the IFAX 101, the predetermined signal (response signal) is a response signal “354”that is output from the mail server 106. On the other hand, in the process receiving email data from LAN 103, the predetermined signal is an OK response output from the mail server 106 after a signal “RETR” was output to the mail server 106.

The mail data communication section 301 receives email data from the first LAN I/F 204 and the second LAN I/F 205 when the email output notification is received from the signal type detecting section 300. The mail data communication section 301 communicates email data based on the email address received from a card information determining section 302, which will be described later.

The card information determining section 302 checks the contents of information that IC card R/W section 203 read out from the IC card 102 inserted into the IC slot section 203A. When the information necessary for a signature process or a signature encryption process is stored in the IC card 102, the information is given to a signature encrypting section 303.

The card information determining section 302 determines whether the IC card 102 is inserted based on the information read by the IC card R/W section 203. Furthermore, the card information determining section 302 checks the email address information stored in the IC card 102 and sends the email address information to the mail data communication section 301.

The signature encrypting section 303 encrypts the signature of the email data received by the mail data communication section 301 based on the information necessary for signature encryption received from the card information determining section 302. The signature encrypting section 303 further decrypts the signature of the email data received by the mail data communication section 301 based on the information necessary for signature encryption (decryption) that is received from the card information determining section 302.

Here, information stored in the IC card 102 is described.

Each user who sends an email from the IFAX 101 has an IC card 102. Email address information given to each user is stored in the IC card. In other words, a user can transmit an email from his/her mail address and can receive an email addressed to his/her email address only when his/her IC card 102 is inserted into the ADPT 100.

The IC card 102 also stores information necessary for processing signature and encrypting signature. In other words, the IC card 102 stores secret key information and public key information. Public key information of addressee is stored in RAM 202 of the ADPT 100.

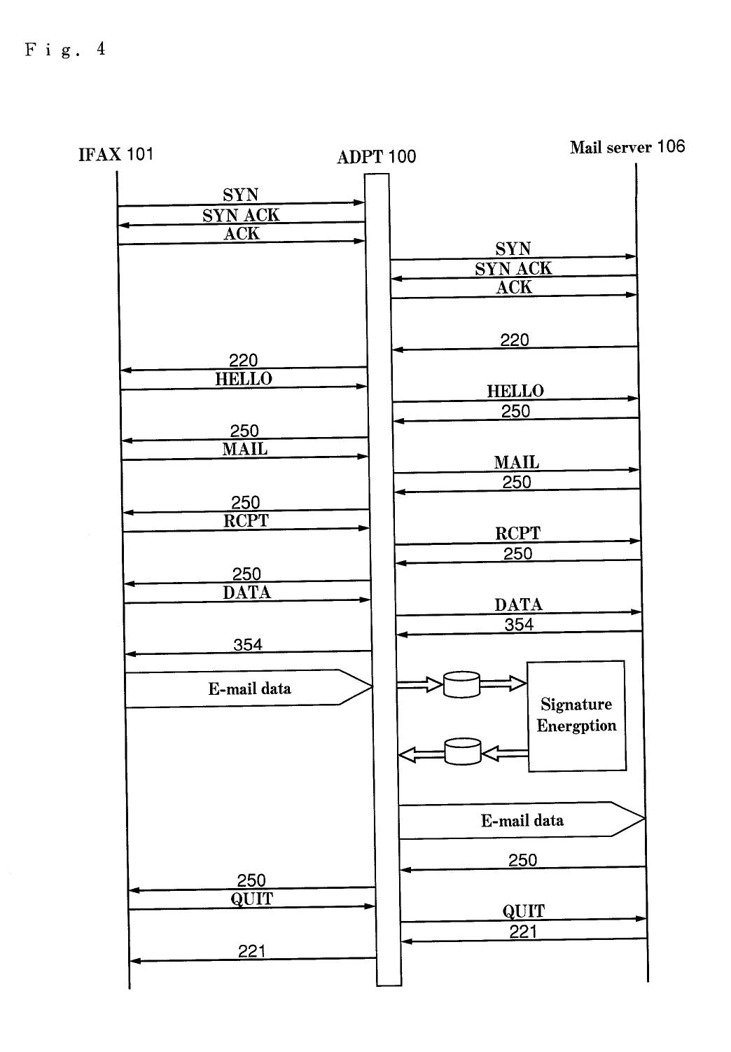

Next, the process of transmitting emails to a mail server 106 from the IFAX 101, to which the ADPT 100 having the configuration (construction) mentioned above is connected, is described using a sequential chart shown in FIG. 4. FIG. 4 shows a sequential chart for the case that the IFAX 101, to which the ADPT 100 of the present embodiment is connected, transmits an email to the mail server 106. Here, it is assumed that SMTP (Simple Mail Transfer Protocol) is used for email transmission. It is also assumed that the email data transmitted from the IFAX 101 are all encrypted.

First, the IFAX 101 establishes connection to the ADPT 100 for transmitting an email to the mail server 106. In more detail, the IFAX 101 transmits a command signal for synchronization (SYN) to the ADPT 100. Then, upon receiving a command signal (SYN ACK), indicating confirmation of synchronization that was transmitted from the ADPT 100 in response to the command signal (SYN), the IFAX 101 transmits a command signal (ACK), indicating the receipt of the command signal (SYN ACK). By this procedure, the connection between the IFAX 100 and the ADPT 100 is established.

After the connection between the IFAX 101 and ADPT 100 is established, the ADPT 100 establishes connection to the mail server 106. The ADPT 100 performs the same procedure as the IFAX 101 did. By this procedure, the connection between the ADPT 100 and the mail server 106 is established.

When the connection between the ADPT 100 and the mail server 106 is established, the mail server 106 outputs a response signal (220), indicating reception-OK, to the ADPT 100. When the “220” signal is received, the ADPT 100 outputs the “220” signal to the IFAX 101 in the same manner as the mail server 106 did.

When the “220” signal is received, the IFAX 101 outputs a command signal (HELLO) to announce the use of a communication path, a command signal (MAIL) indicating a sender of a message and a command signal (RCPT), indicating the addressee of the message to the ADPT 100.

When each of these command signals is received, the ADPT 100 outputs the same command signal to the mail server 106 in the same manner as the IFAX 101 did.

When each of these command signals is received, the mail server 106 outputs a response signal (250), indicating reception-OK, to the ADPT 100. When the “250” signal is received, the ADPT 100 outputs the “250” signal to the IFAX 101 in the same manner as the mail server 106 did.

When the “250” signal is received after an output of the “RCPT” signal to the ADPT 100, the IFAX 101 outputs a command signal (DATA), indicating start of message transmission to the ADPT 100. When the “DATA” signal is received, the ADPT 100 outputs the “DATA” signal to the mail server 106 in the same manner as the IFAX 101 did.

When the “DATA” signal is received, the mail server 106 outputs a response signal (354), indicating reception-OK, to the ADPT 100. When the “354” signal is received, the ADPT 100 outputs the “354” signal to the IFAX 101 in the same manner as the mail server 106 did. In this procedure, the signal type detecting section 300 detects that the “354” signal is a predetermined signal and recognizes that email data will follow (i.e., be output).

When the “354” signal is received, the IFAX 101 outputs email data to the ADPT 100. In the ADPT 100, the mail data communication section 301 receives the email data. The signature encrypting section 303 determines whether it is necessary to encrypt the email data. Here, to encrypt the email data, the signature encrypting section 303 performs signature processing or signature encryption on the email data. After the processing, the mail data communication section 301 outputs the processed email data to the mail server 106.

When the email data is received, the mail server 106 outputs a response signal (250), indicating reception-OK, to the ADPT 100. When the “250” signal is received, the ADPT 100 outputs the “250” signal to the IFAX 101 in the same manner as the mail server 106 did.

When the “250” signal is received after an output of the email data to the ADPT 100, the IFAX 101 outputs a command signal (QUIT), indicating an announcement of the end of use of the communication path, to the ADPT 100. When the “QUIT” signal is received, the ADPT 100 outputs the “QUIT” signal to the mail server 106 in the same manner as the IFAX 101 did.

When the “QUIT” signal is received, the mail server 106 outputs a response signal (221), indicating reception-OK, to the ADPT 100. When the “221” signal is received, the ADPT 100 outputs the “221” signal to the IFAX 101.

With these procedures, the connection between the IFAX 101 and the ADPT 100 and the connection between the ADPT 100 and the mail server 106 are disconnected. Thus, the process in which the IFAX 101 transmits an email to the mail server 106 is terminated.

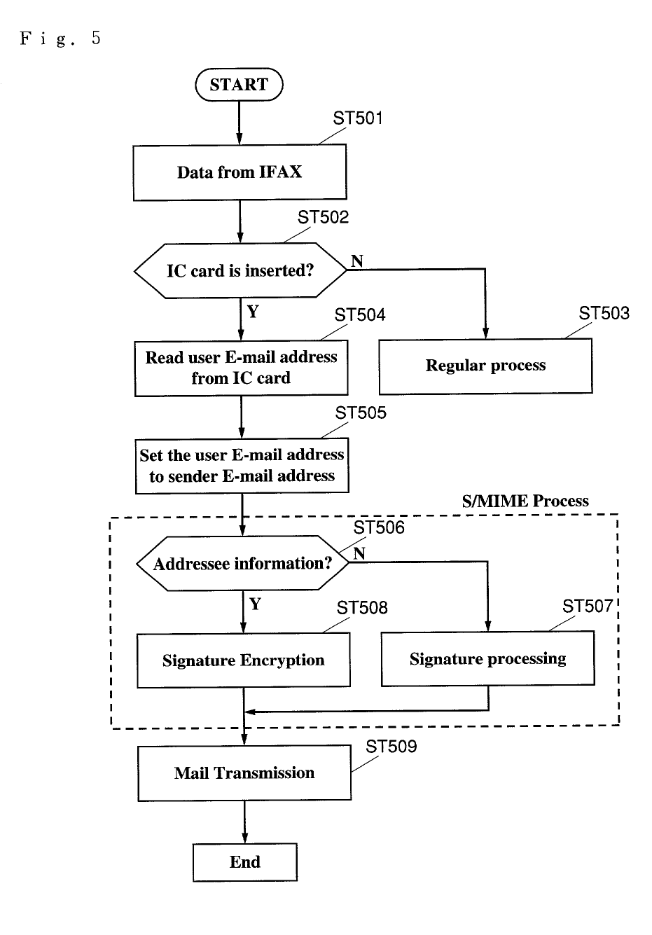

In this sequence, the process that is performed when the ADPT 100 receives email data from the IFAX 101 is described using FIG. 5. FIG. 5 is a flowchart illustrating a process in which the ADPT 100 performs a process, such as signature encryption, on the email data received from the IFAX 101.

When the email data is received from the IFAX 101 (ST501), the card information determining section 302 determines whether the IC card 102 is inserted into the IC card slot section 203A of the ADPT100 (ST502). When the IC card 102 is not inserted into the slot section 203A of the ADPT 100, the ADPT 100 performs a regular process for transmitting an email (ST503). In other words, an email is transmitted from the email address assigned to the IFAX 101.

On the other hand, when it is determined that the IC card 102 is inserted into the slot section 203A, the IC card R/W section 203 retrieves the email address information of the user from the IC card 102 (ST504).

Further, the card information determining section 302 checks the email address information retrieved by the IC card R/W section 303 and informs the email address information to the mail data communication section 301. The mail data communication section 301 sets the email address information as the sender information of the email (ST505). More specifically, the retrieved email address information is put to the “From:” section in the header of the email.

When the sender information of the email is set, the ADPT 100 determines whether there is addressee information (ST506). More specifically, it is determined whether public key information is stored in the RAM 202 of the ADPT 100.

When there is no addressee information, the card information determining section 302 sends its own secret key information stored in the IC card 102 to the signature encrypting section 303. The signature encrypting section 303 performs the signature processing using its own secret key information (ST507).

More specifically, after the signature encrypting section 303 obtains a message digest from the message data of email data by performing an operation of an irreversible function, such as a hash function, the signature encrypting section 303 encrypts the message digest using its own secret key information.

On the other hand, when there is addressee information, the signature encrypting section 303 obtains the addressee's public key information. The card information determining section 302 sends its own secret key information stored in the IC card 102 to the signature encrypting section 303. The signature encrypting section 303 performs signature encryption by using its own secret key information and the addressee's public key information (ST508).

More specifically, after obtaining a message digest from the message of the email by performing an irreversible function, such as a hash function, as described above, the signature encrypting section 303 encrypts the message digest using its own secret key information. And then, the signature encrypting section 303 generates a secret key called DEK (Data Encryption Key) using pseudo random numbers and encrypts the DEK by using the addressee's public key information. On the other hand, the message digest (signature result) encrypted previously and email message are encrypted using the DEK according to a predetermined encrypting method (e.g., DES: Data Encryption Standard).

Then, the mail data communication section 301 sends the email data on which the signature encryption, or the like, is performed in ST507 or ST508 (ST509). Thus, the signature encryption process, or the like, is completed for the email that the ADPT 100 received from the IFAX 101.

Thus, according to the ADPT 100 of the present embodiment, confidentiality of emails can be secured, without addition of any special construction to an existing IFAX, because the ADPT 100 of this embodiment can encrypt email data, if necessary, when the IFAX 101 transmits email data.

When emails are encrypted, the ADPT 100 checks existence of IC cards 102 delivered to each user to determine the necessity of encryption. Thus, the necessity of encryption is easily determined, because email data that need not be encrypted are transmitted without encryption and emails necessary to be encrypted are transmitted after the encryption.

Further, when emails are encrypted, the ADPT 100 uses information that is necessary for encryption and is stored in the IC card 102, to encrypt the emails. Since encryption is performed using the information stored in the IC card that is managed by each user, the email can be prevented from being rewritten.

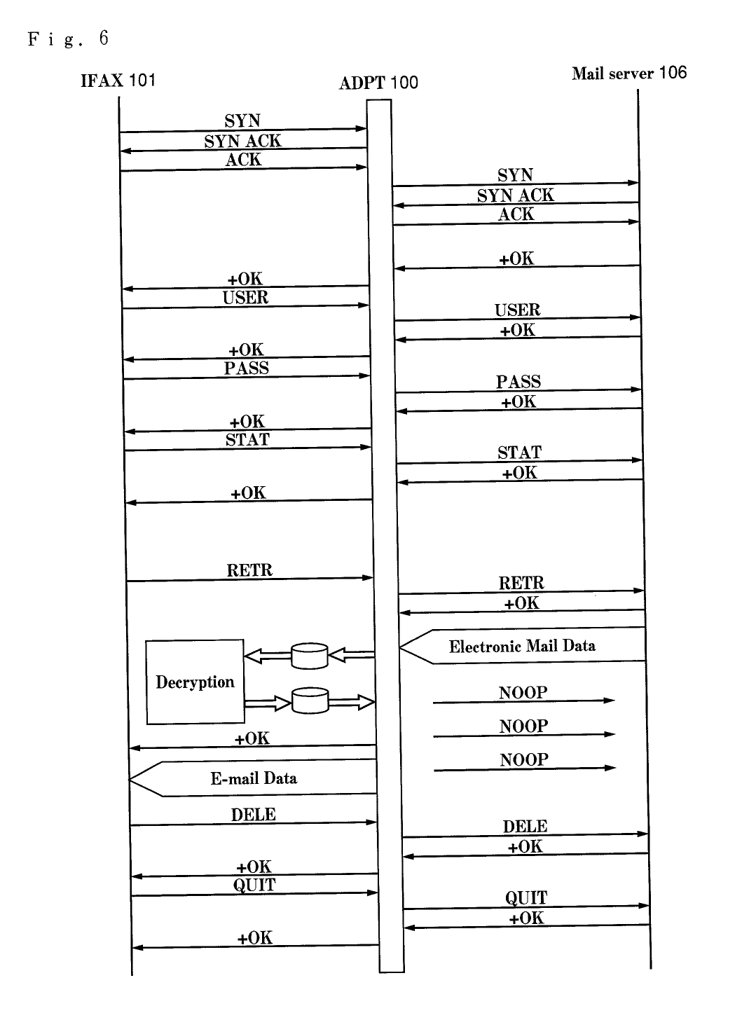

Next, the process in which the IFAX 101, to which the ADPT 100 is connected, receives email data from the mail server 106 is described using the sequential chart shown in FIG. 6. FIG. 6 is a sequential chart when the IFAX 101, to which the ADPT 100 of the present embodiment is connected, receives email data from the mail server 106. Here, it is assumed that the process of receiving email data is performed according to POP3 (Post Office Protocol ver. 3). Further, it is assumed that email data received from the mail server 106 are all encrypted.

When email data are received from the mail server 106, the IFAX 101 executes a procedure to establish connection with the ADPT 100 in the same manner as the email data transmission process mentioned above. Thus, by the execution of the same procedure described above, the connection between the IFAX 101 and the ADPT 100, and the connection between the ADPT 100 and the mail server 106 are established.

After the connection between the ADPT100 and the mail server 106 is established, the mail server 106 outputs an OK-response as a sign indicating start of POP service to the ADPT 100. When the OK-response is received, the ADPT 100 outputs the OK-response to the IFAX 101 in the same manner as the mail server 106 did.

When the OK-response is received, the IFAX 101 outputs a command signal (USER), indicating transmission of a mailbox name, a command signal (PASS), indicating transmission of a mailbox password and a command signal (STAT), indicating an inquiry of reception status, to the ADPT 100.

When each of these command signals is received, the ADPT 100 outputs the same command signal to the mail server 106 in the same manner as the IFAX 101 did.

When each of these command signals is received, the mail server 106 outputs an OK-response as an affirmative response to the ADPT 100. When the OK-response is received, the ADPT 100 outputs the OK-response to the IFAX 101 in the same manner as the mail server 106 did.

When the OK-response is received after the “STAT” is output to the ADPT 100, the IFAX 101 outputs a command signal (RETR), indicating a request for download of a mail, to the ADPT 100. When the “RETR” signal is received, the ADPT 100 outputs the “RETR” to the mail server 106 in the same manner as the IFAX 101 did.

When the “RETR” signal is received, the mail server 106 outputs an OK-response as an affirmative response to the ADPT 100. At this time, the signal type detecting section 300 of the ADPT 100 detects that the OK-response is a predetermined response signal and recognizes that email data will follow (i.e., be output next). Subsequently, the mail server 106 outputs email data to the ADPT 100. The mail data communication section 301 of the ADPT 100 receives the email data. The signature encrypting section 303 determines whether the email data are encrypted. Here, since the email data are encrypted, the signature encrypting section 303 decrypts the encrypted email data.

After the decryption, the ADPT100 outputs an OK-response as an affirmative response to the IFAX 101 and outputs the decrypted email data to the IFAX 101. On the other hand, the ADPT100 outputs a command signal (NOOP), indicating non-operation, to the mail server 106.

When the email data is received, the IFAX 101 outputs a command signal (DELE), indicating a request for deleting the email to the ADPT 100. When the “DELE” signal is received, the ADPT 100 outputs the “DELE” signal to the mail server 106 in the same manner as the IFAX 101 did.

When the “DELE” signal is received, the mail server 106 outputs an OK-response as an affirmative response to the ADPT 100. When the OK-response is received, the ADPT 100 outputs the OK-response to the IFAX 101 in the same manner as the mail server 106 did.

When the OK-response is received after the “DELE” signal is output to the ADPT 100, the IFAX 101 outputs a command signal (QUIT), indicating a notification of completion, to the ADPT 100. When the “QUIT” signal is received, the ADPT 100 outputs the “QUIT” signal to the mail server 106 in the same manner as the IFAX 101 did.

When the “QUIT” signal is received, the mail server 106 outputs an OK-response as an affirmative response to the ADPT 100. When the OK-response is received, the ADPT 100 outputs the OK-response to the IFAX 101 in the same manner as the mail server 106 did.

According to these procedures, the connection between the IFAX 101 and the ADPT 100 and the connection between the ADPT100 and the mail server 106 are disconnected and the process of receiving email data from the mail server 106 is completed.

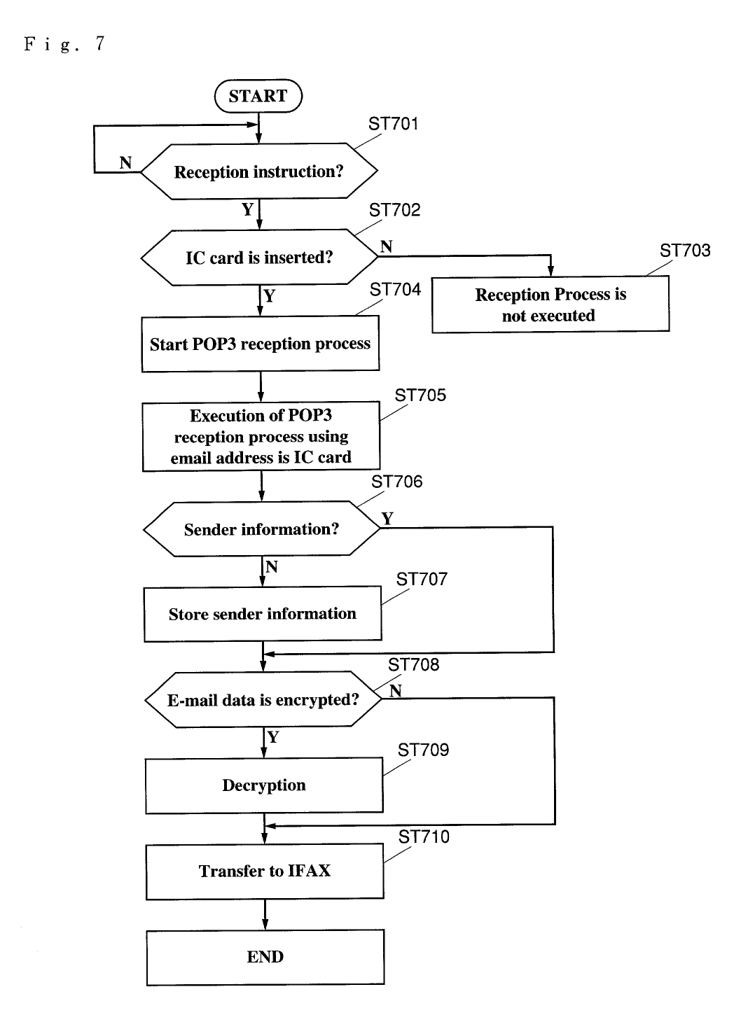

A process in which the ADPT 100 receives email data from the mail server 106 in the above-described sequence is described with reference to FIG. 7. FIG. 7 is a flowchart of the process in which the ADPT 100 receives email data from the mail server 106 and decrypts the email data encrypted by a signature encrypting process, and the like.

When email data are received, the ADPT 100 determines whether there is a reception instruction of email from the IFAX 101 (ST701). The reception instruction can be an instruction input by a user of the IFAX 101 through an input device, such as a keyboard, or can be an instruction based on auto pilot function, which automatically checks email arrivals at predetermined time intervals.

When there is a reception instruction, the card information determining section 302 determines whether an IC card 102 is inserted into the slot 203A of the ADPT 100 (ST702). When the IC card 102 is not inserted into the slot 203A of the ADPT 100, the ADPT 100 does not execute a reception process, because the ADPT 100 cannot confirm mail address information of the user who sent the (reception) instruction from the IFAX 101 (ST703).

On the other hand, when the IC card 102 is inserted in the slot 203A of the ADPT 100, the ADPT 100 executes the reception process based on POP3 (ST704). More specifically, the card information determining section 302 checks the email address information extracted from the IC card 102 by the IC card R/W section 203 and informs the mail data communication section 301 of the email address. The mail data communication section 301 starts the reception process of email data using the mail address according to POP3 (ST705).

When the reception process of email starts, the ADPT 100 determines whether there is sender information (ST706). More specifically, it determines whether there is public key information of a sender in the RAM 202 of the ADPT 100. The public key information is used for decrypting an encrypted message digest of an email.

When there is no public key information of the sender in the RAM 202, the public key information of the sender attached to the email is stored in the RAM 202 of the ADPT 100 (ST707). Then, the signature encrypting section 303 determines whether the email data are encrypted (ST708). On the other hand, when there is public key information of the sender, it is determined whether the email data are encrypted without storing the public key information (ST708).

Since, in this embodiment, it is assumed that the email data are encrypted, the signature encrypting section 303 receives the email data from the mail data communication section 301 and decrypts the email data (ST709).

More specifically, the encrypted DEK is decrypted by its own key information, and then, the encrypted data are decrypted using the decrypted DEK. Then, email data in the decrypted data, is divided into a message digest and message data. At this time, the message digest is decrypted using public key information of the sender, and the decrypted result is stored. On the other hand, another message digest is extracted from the divided message data using a hash function mentioned above. Then, the message digest obtained (extracted) here is compared with the message digest stored previously. Thus, it is possible to confirm whether the message data of the email is rewritten (altered) or is the one sent from a right (or an authorized) sender.

When message data are not encrypted, the signature encrypting section 303 decrypts only the message digest and confirms whether the message is sent from a right (or an authorized) sender.

The mail data communication section 301 receives the email data decrypted as mentioned above from the signature encrypting section 303 and transfers the email to the IFAX 101 (ST710). Thus, the process in which the ADPT 100 receives email data from the mail server 106 completes.

According to the ADPT 100 of the present embodiment, upon the reception of an email, it is determined whether the email is encrypted. When encrypted, the encrypted email data is decrypted and transferred to the IFAX 101. Accordingly, it is possible to receive emails while confidentiality of the email is ensured, without addition of any special components or construction to an existing IFAX machine.

In the reception process of emails, the ADPT 100 checks existence of an IC card 102 delivered to each user. When the IC card 102 does not exist, the ADPT 100 does not execute the reception process of emails. Thus, it is possible to perform authentication of a receiver, upon the reception of the email. Thus, it is possible to avoid the situation in which another person sees email data for the receiver, even in the case that many people share (use) a single IFAX 101.

Here, in this embodiment, the IC card 102 has a configuration such as a memory card that stores information necessary for signature encryption, or the like. However, the configuration of the IC card 102 is not limited thereto. Rather, it is also possible to store a program for signature encryption, or the like, in the IC card 102 and to perform all or a part of signature encryption process in the IC card 102. In this case, for example, a part of the encrypting or decrypting process can be performed in the IC card 102, after receiving an encrypted message digest or an encrypted DEK to be processed from the ADPT 100. Since the IC card receives predetermined data and a process, such as an encrypting process, is executed in the IC card, it is possible to more securely prevent the information necessary for an encryption process, or the like, from being seen by other people, comparing with the case in which the IC card simply stores information necessary for encrypting process, or the like.

In this embodiment, the IC card 102 stores information necessary for the encrypting process and the like, and an encrypting device 100 executes processes, such as an encrypting process. However, it is also possible to store information necessary for the encrypting process, or the like, in the memory of the encrypting device 100. Even in this modification, the same effect as that of the above-described embodiment can be achieved.

As described above, according to the present invention, it is possible to ensure confidentiality of emails transmitted from IFAX, without addition of any special components or construction to the existing IFAX, because the encrypting device of the present invention can be connected to all types of existing IFAX 101, can encrypt email data, and can decrypt the encrypted email data.

It is noted that the foregoing examples have been provided merely for the purpose of explanation and are in no way to be construed as limiting of the present invention. While the present invention has been described with reference to certain embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

The present disclosure relates to subject matter contained in priority Japanese Application No. 2000-220189, filed on Jul. 21, 2000, which is herein expressly incorporated by reference in its entirety.

What is claimed is:

1. An encrypting device comprising:
a first interface section connected to an Internet facsimile machine;
a second interface section connected to a network;
a signal type detecting section that detects a type of a signal communicated via at least one of the first and second interface sections;
a mail communication section that receives an email when the signal type detecting section detects a predetermined signal type; and
an encrypting section that performs at least one of encryption and decryption on the email data received by the mail communication section.

2. An encrypting device according to claim 1, wherein the signal type detecting section relays the signal to a recipient when a signal type other than the predetermined signal type is detected.

3. An encrypting device according to claim 1, further comprising:
an IC card in which information necessary for the at least one of encryption and decryption of the encrypting section is stored; and
a slot section into which the IC card is inserted,
wherein the encrypting section performs the at least one of encryption and decryption using information stored in the IC card, when the IC card is inserted in the slot section.

4. An encrypting device according to claim 3, wherein the IC card stores email address information, and the mail communication section performs a transmission-reception process of email data using the email address information stored in the IC card, when the IC card is inserted in the slot section.

5. An encrypting device comprising:
a first interface section connected to an Internet Facsimile machine;
a second interface section connected to a network;
a signal type detecting section that detects a type of a signal communicated via at least one of the first and second interface sections;
a mail communication section that receives email data when the signal type detecting section detects a predetermined signal type;
an IC card that performs the at least one of encryption and decryption of the email data; and
a slot section in which the IC card is inserted.

6. An encrypting method comprising:
detecting a predetermined signal type from a signal received via a first interface section connected to an Internet facsimile machine;
receiving email data when the predetermined signal type is detected;
encrypting the received email data; and
transmitting the encrypted email data via a second interface section connected to a network.

7. A decrypting method comprising:
detecting a predetermined signal type from a signal received via a first interface section connected to a network;
receiving email data when the predetermined signal type is detected;
determining whether the email data is encrypted;
decrypting the email data when the email data is encrypted; and
transmitting the decrypted email data via a second interface section connected to an Internet facsimile machine.
